(19) United States
(12) Patent Application Publication
(10) Pub. No.: US 2024/0411780 A1
(43) Pub. Date: Dec. 12, 2024

(54) CHANGE-POINT DETECTION APPARATUS, CHANGE-POINT DETECTION METHOD AND PROGRAM

(71) Applicant: NIPPON TELEGRAPH AND TELEPHONE CORPORATION, Tokyo (JP)

(72) Inventors: Shoko TAKAHASHI, Tokyo (JP); Kei TAKESHITA, Tokyo (JP)

(21) Appl. No.: 18/702,548

(22) PCT Filed: Nov. 15, 2021
(86) PCT No.: PCT/JP2021/041966

§ 371 Date: Apr. 18, 2024

(51) Int. Cl. G06F 16/28; G06F 16/25

(52) U.S. Cl. CPC G06F 16/285; G06F 16/258; G06F 16/283

(57) ABSTRACT

The present disclosure aims to detect an occurrence time point of a certain change as a change point when the change including a change in a time change pattern such as a change in a periodic fluctuation occurs, with respect to time-series data including data not satisfying a stationarity restriction or iid restriction indicating a periodic fluctuation. Therefore, the content of the present disclosure is a change point detector including an input unit that inputs time-series data representing a system state at each time point of a system including one or a plurality of devices, the time-series data being constituted by data of a dimension of the number of devices included in the system×the number of items representing a state of the devices, a time window generation conversion unit that generates converted data by converting the time-series data at each time point from data of the dimension of the number of devices×the number of items into data of a dimension of the number of devices×the number of items×a time window length, and a detection unit that detects a change point score of a system state calculated based on the converted data at each time point as a change point when the change point score exceeds a preset threshold.

### TECHNICAL FIELD

The present disclosure relates to a change point detector, a change point detection method, and a program.

### BACKGROUND ART

Techniques for detecting a change point of a system state of a system including one or a plurality of devices by using time-series data representing a system state at each time point are known. Here, “system state” refers to an operating state of a system represented by quantitative variables such as “access count” and “user count”.

Techniques described in NPL 1 to NPL 4 are known as techniques for detecting a change point for time-series data to which a correct answer label about the occurrence position of the change point is not given.

NPL 1 proposes a method of calculating the degree of change by evaluating the distance between subspaces constituted by partial time series by using a subspace method. This is a method of generating a matrix in which partial time series (a time window cut out from time series) are bundled for each of the past period and the current period, extracting characteristic patterns by using singular value decomposition, and evaluating the distance between the characteristic patterns.

NPL 2 proposes a method of estimating a probability distribution of a new section based on data observed from a previous change point by using a probability model. This is a method of detecting the change point by estimating a probability distribution of the continuous length from the last change point (elapsed time to the next change point) based on the Bayesian theory. Further, the “Bayesian theory” is a theory indicating that “a possibility of occurrence of a matter can be roughly estimated by using the past occurrence frequency of that matter”.

NPL 3 proposes a method of classifying the state of time series data by using clustering and determining that a change has occurred when a new observation value is not appropriate for any existing cluster. This is a method of determining for all existing clusters whether the Euclidean distance between a new observation value and the centroid of an existing cluster exceeds the radius of a corresponding cluster and for detecting the distance as a change point when all of the Euclidean distances exceed the radius of the cluster.

On-line change detection based on two-step learning in NPL 4 is a kind of likelihood ratio test for determining whether there is a significant difference between probability densities of two consecutive sections based on a likelihood ratio, and a method of calculating a change point score while removing an outlier by two-step learning of an autoregressive model is proposed. Specifically, this is a method in which, as the first-stage learning, a probability density function based on the autoregressive model is learned in time series observed up to the immediately preceding point and a logarithmic loss function under the probability density function is calculated as an outlier score for newly observed data. Furthermore, this is a method in which the outlier score sequence is smoothed, and then as second-stage learning, a probability density function based on the autoregressive model is likewise learned from the smoothed outlier score sequence calculated up to the immediately preceding time point, a logarithmic loss function under the probability density function is calculated for an outlier score calculated from newly observed data, and further the smoothed outlier score is set as a change point score.

In addition, as a similar technique, NPL 5 describes a technique of detecting a non-stationary fluctuation of a system including one or more devices by using time series data representing a system state at each time point. Specifically, this is a method of extracting cluster transitions between different clusters by performing state classification of time-series data using clustering and tracking clusters assigned to each time point in a time axis direction. Furthermore, this is a method of calculating the appearance frequency of each cluster transition pattern of a certain past period, and detecting as a non-stationary fluctuation when the appearance frequency of the newly observed cluster transition pattern of the past period is lower than a preset threshold.

### CITATION LIST

### Non Patent Literature

NPL 1: T. Ide and K. Tsuda, “Change-Point Detection Using, Krylov Subspace Learning,” n Procs. of the SIAM International Conference on Data Mining, April 2007.
NPL 2: R. P. Adams and D. J. C. Mackay, “Bayesian Oline Changpoint Detection,” arXiv: 0710.3742 October 2007.
NPL 3: D. H. Tran, “Automated Change Detection and Reactive Clustering in Multivariate Streaming Data,” arXiv: 1311.55 November 2013.
NPL 4: Yamanishi, “Anomaly Detection: Outlier Detection and Change Detection,” REAJ magazine 2015 Vol. 37, No. 3, 2015.
NPL 5: Takahashi, Ikegami, “Proposal of Unsteady Fluctuation Detection Technique for Multidimensional Time Series Data,” IEICE Technical Report, CQ2020-32, pp. 57-62, July 2020.

### SUMMARY OF INVENTION

### Technical Problem

However, the change point detection technique based on the subspace method proposed by NPL 1 has a limitation that the time series to be detected must be a stationary process. That is, it is necessary to satisfy weak stationarity that an expected value of a target time series and self-covariance thereof are constant regardless of time.

Furthermore, the change point detection technique based on the Bayesian theory proposed in NPL 2 has a restriction that the time series to be detected must be independently and identically distributed (iid). In other words, it is necessary that the data at each time point constituting the time series be independent in accordance with the same probability distribution. However, time-series data observed in many systems represented by a network system often show periodic fluctuations such as time zone fluctuations, day-of-week fluctuations and month fluctuations, and furthermore, since there are many kinds of periodic fluctuations having different periods, the change point detection technique which is subject to the restrictions such as the stationarity restriction and the iid restriction cannot be applied.

On the other hand, the technique of detecting a change point by clustering proposed by NPL 3 and the technique of detecting an on-line change based on the two-stage learning proposed by NPL 4 are considered as promising in that no target time series is restricted by the stationarity restriction or the iid restriction. However, the technique of detecting a change point by clustering proposed by NPL 3 classifies the state of snapshot data at each time point cut out from the time series data, and determines whether the classified state is different from the existing state, but does not consider the time axis. That is, in time-series data in which a temporal change of a state follows a certain pattern, such as time-series data indicating a periodic fluctuation observed in many systems, when the time change pattern changes at the boundary of a certain moment, this change point cannot be detected.

Furthermore, the technique of detecting an on-line change based on two-stage learning proposed by NPL 4 is a method based on the autoregressive model, and therefore it can be said that the time axis is considered. Therefore, the method is considered to be promising for time-series data in which the time change pattern changes at the boundary of a certain moment. However, it is difficult to cope with time-series data in which a plurality of kinds of periodic fluctuations having different periods such as a time zone fluctuation, a day-of-week fluctuation, and a month fluctuation are mixed with each other by an autoregressive model.

In addition, the technique of detecting non-stationary fluctuation proposed by NPL 5 is a technique based on clustering in which the target time series is not restricted, in which the time axis is considered by a method of tracking a cluster transition in the time axis direction. However, the corresponding technique is a technique for detecting a cluster transition pattern in which an appearance frequency calculated in a certain past period is less than a preset threshold as a non-stationary variation, and only determining whether an individual cluster transition is in an abnormal state (the appearance frequency is low) as compared with the past results, and is not for detecting a change point which can be said to be a start of a continuous abnormal state.

The present invention has been made in view of the above-mentioned points, and aims to detect an occurrence time point of a certain change as a change point when the change including a change in a time change pattern such as a change in a periodic fluctuation occurs, with respect to time-series data including data not satisfying the stationarity restriction or iid restriction indicating a periodic fluctuation.

### Solution to Problem

In order to achieve the above object, the present invention according to claim 1 is a change point detector including an input unit that inputs time-series data representing a system state at each time point of a system including one or a plurality of devices, the time-series data being constituted by data of a dimension of the number of devices included in the system×the number of items representing a state of the devices, a time window generation conversion unit that generates converted data by converting the time-series data at each time point from data of the dimension of the number of devices×the number of items into data of a dimension of the number of devices×the number of items×a time window length, and a detection unit that detects a change point score of a system state calculated based on the converted data at each time point as a change point when the change point score exceeds a preset threshold.

### Advantageous Effects of Invention

As described above, according to the present invention, even for time-series data which does not satisfy the stationarity restriction and the iid restriction indicating a periodic fluctuation, when a certain change including a change in a time change pattern such as a change in a periodic fluctuation occurs, the occurrence time point of the change can be detected as a change point.

### BRIEF DESCRIPTION OF DRAWINGS

FIG. 1 is a diagram illustrating an exemplary functional configuration of a change point detector according to the present embodiment.

FIG. 2 is a flowchart illustrating an example of a change point detection process according to the present embodiment.

FIG. 3 is a diagram illustrating an exemplary hardware configuration of the change point detector according to the present embodiment.

### DESCRIPTION OF EMBODIMENTS

Hereinafter, an embodiment of the present invention will be described. In the present embodiment, a change point detector 10 which can detect an occurrence time point of a certain change as a change point when the change occurs in a system state by using time-series data representing a system state at each time point of a system(S) including one or a plurality of devices will be described. Here, the “system state” means an operating state of the system represented by quantitative variables such as “access count” and “user count”.

### Functional Configuration

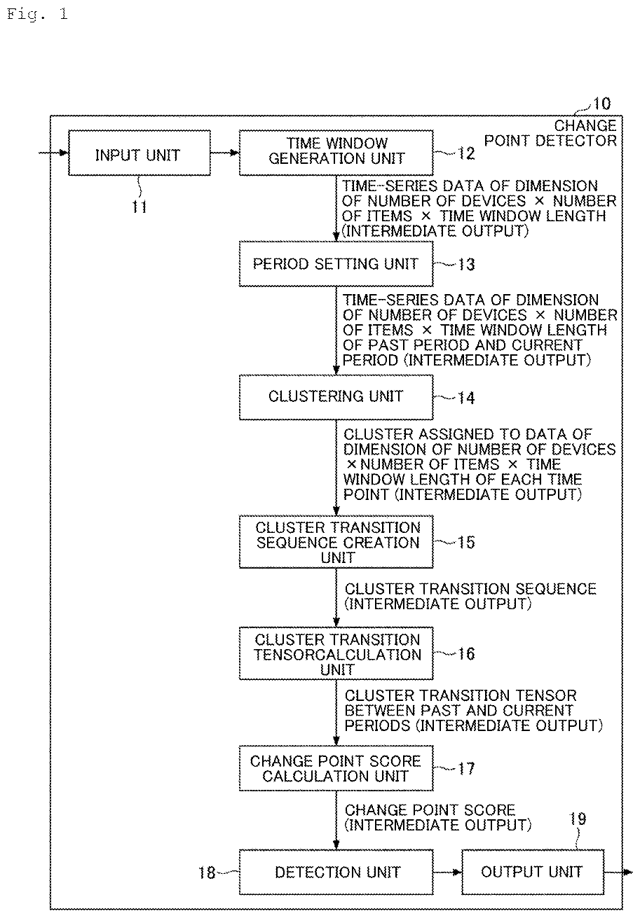

First, a functional configuration of the change point detector 10 according to the present embodiment will be described with reference to FIG. 1. FIG. 1 is a diagram illustrating an exemplary functional configuration of the change point detector according to the present embodiment.

As illustrated in FIG. 1, the change point detector 10 according to the present embodiment includes an input unit 11, a time window generation unit 12, a period setting unit 13, a clustering unit 14, a cluster transition sequence creation unit 15, a cluster transition tensor calculation unit 16, a change point score calculation unit 17, a detection unit 18, and an output unit 19. Further, the “device” in the “number of devices” and the “state of the device” shown below indicates a device constituting a system in which detection is to be performed by the change point detector 10 for a change point.

The input unit 11 inputs time-series data representing a system state at each time point of a system(S) including one or a plurality of devices, and time-series data composed of data of (the number of devices×the number of items representing the state of the devices) dimensions constituting the system(S).

The time window generation unit 12 divides the time-series data input by the input unit 11 into time windows of a fixed length, converts the data at each time point from data of (the number of devices×the number of items) dimensions to data of (the number of devices×the number of items×the time window length) dimensions to generate converted data, and performs intermediate output.

The period setting unit 13 extracts time-series data of a previously set past period and a present period from the time-series data of the (the number of devices×the number of items×the time window length) dimensions generated by the time window generation unit 12, and performs intermediate output.

The clustering unit 14 classifies the data of the dimension of (the number of devices×the number of items×the time window length) at each time point constituting the time-series data of the past period and the present period extracted by the period setting unit 13 by using a clustering method and then performs intermediate output.

The cluster transition sequence creation unit 15 tracks clusters allocated by the clustering unit 14 to the (the number of devices×the number of items×the time window length)-dimensional data at each time point of the past period and the current period in a time axis direction, creates a sequence of cluster transitions between different clusters for each of the past period and the current period, and simultaneously grants a stay period for the cluster to each cluster constituting the cluster transition sequences, and performs intermediate output.

The cluster transition tensor calculation unit 16 extracts a cluster transition of a preset fixed length from the cluster transition sequence created by the cluster transition sequence creation unit 15, then calculates an appearance probability of each cluster transition pattern of the past period and the current period, sets the cluster transition length (the length of the cluster transition) as a rank (i.e., dimension), has unique values of all clusters appearing in the past period and the current period in an index of each dimension, calculates a cluster transition tensor having the appearance probability of the cluster transition pattern as a value for each of the past period and the current period, and performs intermediate output.

The change point score calculation unit 17 calculates a distance between the cluster transition tensor of the past period and the cluster transition tensor of the current period as a degree of change from the past period to the current period based on the cluster transition tensor of each of the past period and the current period calculated by the cluster transition tensor calculation unit 16, and performs intermediate output.

The detection unit 18 detects a change point score as a change point when the change point score calculated by the change point score calculation unit 17 exceeds a preset threshold. That is, the detection unit 18 detects the change point score as a change point when the score of the change point of the system state calculated based on data (converted data) at each time point exceeds a preset threshold.

The output unit 19 outputs the change point detected by the detection unit 18.

### [Change Point Detection Process]

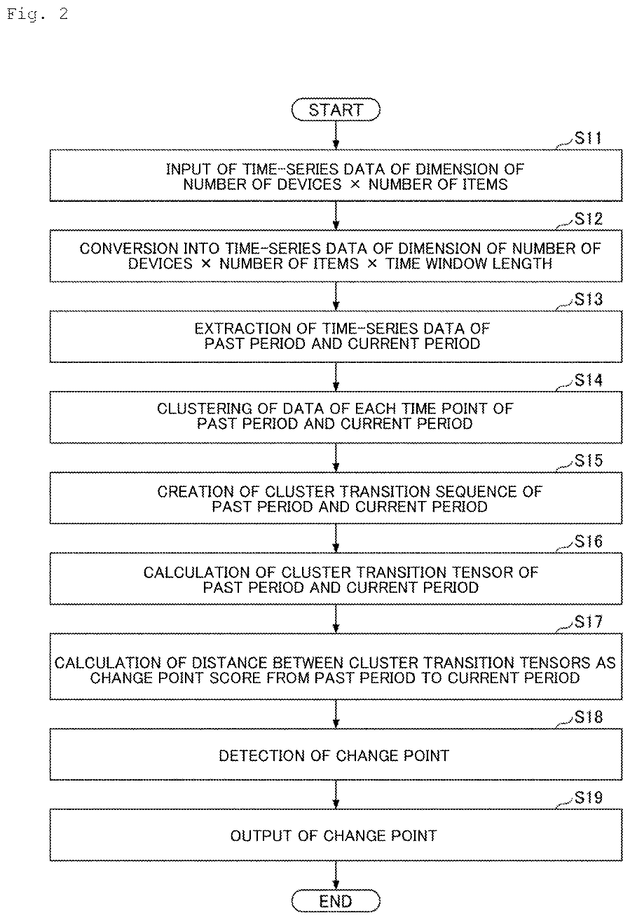

Next, a change point detection process (procedure) according to the present embodiment will be described with reference to FIG. 2. FIG. 2 is a flowchart showing an example of the change point detection process according to the present embodiment.

Thereafter, it is assumed that the time series data is composed of N pieces of M×K-dimensional data in which M is the number of devices included in the system(S), K is the number of items of data representing a system state at each time point, and N is the number of observation time points of time-series data.

Further, each element of M×K-dimensional data at each time point is K observation values representing the state of M devices at that time point. More specifically, when the M×K-dimensional data at a certain time point is set as [x₁, . . . , x_{K}, x_{K+1}, . . . , x_{2K}, x_{(M-1)K+1}, . . . , x_{MK}], for example, x_{(m-1)K+1}, . . . , x_{mK} are K observation values of an m-th device at the time point when m=1, . . . , M.

Step S11: First, the input unit 11 inputs time-series data composed of N pieces of M×K (the number of devices×the number of items)-dimensional data. That is, assuming that M×K-dimensional data at a time point n is set as Xₙ, the input unit 11 inputs time-series data (X₁, . . . , Xₙ).

Step S12: Next, the time window generation unit 12 divides the time series data input in step S11 into time windows of a fixed length W, converts the data at each time point from M×K (the number of devices X the number of items)-dimensional data to M×K×W (the number of devices X the number of items X the time window length)-dimensional data, and performs intermediate output. Specifically, a M×K×W-dimensional vector Yₙ=(X_{n-(W-1)}, X_{n-(W-2)}, . . . , Xₙ) constituted by M×K-dimensional data X_{n-(w-1)}, X_{n-(W-2)}, . . . , Xₙ of each of times points n−(W−1), n−(W−2), . . . , n is set as M×K×W-dimensional data at the time point n. Further, when the original M×K-dimensional data X, is observed at the time points n=1, . . . , N, the M×K×W-dimensional data Yₙ after conversion is obtained at the time points n=W, . . . , N.

Step S13: Next, the period setting unit 13 extracts the time-series data of a previously set past period and a current period from the of M×K×W (the number of devices×the number of items X the time window length)-dimensional time-series data generated in step S12. Specifically, when the past period is set as [s1, e1] and the present period is set as [s2, e2], data of the past period {Y_{S1}, . . . , Yₑ₁} and data of the present period (Y_{S2}, . . . , Yₑ₂) are extracted from the M×K×W-dimensional data Y, at the time points n=W, . . . , N.

Step S14: Next, a clustering unit 14 classifies the (e1−s1+e2−s2+2) M×K×W (the number of devices X the number of items X the time window length)-dimensional data constituting the time-series data of the past period at a time having the length (e1−s1+1) and the current period at a time point having the length (e2−s2+1) extracted in step S13 by using a clustering method to obtain a cluster sequence corresponding to the time-series data. Specifically, when a cluster to which the M×K×W-dimensional data Y, at the time point n belongs is defined as Cn, the clustering unit 14 obtains a cluster sequence {Cₛ₁, . . . , Cₑ₁} from the time-series data {Yₛ₁, . . . , Yₑ₁} of the past period and a cluster sequence {C_{S2}, . . . , Cₑ₂} from the time-series data {Yₛ₂, . . . , Yₑ₂} of the current period. Further, the clustering is a process of classifying (e1−s1+e2−s2+2) pieces of M×K×W-dimensional data that are in a close distance into the same cluster based on the distance between the pieces. Clusters assigned to the M×K×W-dimensional data are arranged in a time series order to obtain a cluster sequence. As the clustering method, hierarchical methods (for example, the shortest distance method, the longest distance method, the group average method, the Ward's method, or the like) may be used, or a non-hierarchical method (for example, a K-Means method, or the like) may be used.

Step S15: The cluster transition sequence creation unit 15 tracks clusters allocated in step S14 to the M×K×W (the number of devices×the number of items×the time window length)-dimensional data at each time point of the past period [s1, e1] and the current period [s2, e2] in the time axis direction, creates a sequence of cluster transitions between different clusters for each of the past period and the current period, and simultaneously grants a stay period for the cluster to each cluster constituting the cluster transition sequences. Specifically, to explain with the example in which a cluster sequence {Cₛ₁, . . . , Cₑ₁} obtained from the time-series data {Yₛ₁, . . . , Yₑ₁} of the past period [s1, e1], when a time point at which a cluster transition occurs between different clusters in the section [s1, e1] is set as τi (i=1, 2, . . . , I) (where, τ₁=s1) and the cluster of the post-transition cluster at the time point mi is set as c(τᵢ), the cluster transition sequence c(τᵢ)→c(τ₂)→ . . . c(τ_{I}) of a length I is obtained by arranging the clusters in the time series order. τ Furthermore, by granting a stay period d(τᵢ)=τᵢ₊₁−τᵢ (where, τ_{I+1}=e1) in the cluster c(τᵢ) to each cluster c(τᵢ) constituting the cluster transition sequence, a cluster transition sequence c(τᵢ)|d(τ₁)→c(τ₂)|d(τ₂)→ . . . →c(τ_{I})|d(τ_{I}) is obtained.

Step S16: The cluster transition tensor calculation unit 16 extracts a cluster transition of a preset fixed length L from the cluster transition sequence created in step S15, then calculates an appearance probability of each of cluster transition patterns of the past period and the current period, sets the cluster transition length L as a rank (i.e., dimension), has unique values of all clusters appearing in the past period and the current period in an index of each dimension, and calculates a cluster transition tensor and having the appearance probability of the cluster transition pattern as a value for each of the past period and the current period. Specifically, to explain a cluster transition sequence c(τ₁)→c(τ₂)→ . . . →c(τ_{I}) having the length I obtained from the time-series data {Yₛ₁, . . . , Yₑ₁} of the past period [s1, e1] as an example, (I−(L−1)) cluster transitions of the length L (where L<=I) can be extracted from the cluster transition sequence and expressed by c(τ_{i-(L-1)})→c(τ_{i-(L-2)})→ . . . →c(τᵢ) (i=L, . . . , I). The cluster transition tensor calculation unit 16 sorts the (I−(L−1)) cluster transitions for each pattern to calculate an appearance probability, and calculates an L-dimensional cluster transition tensor based on the appearance probability. Here, the appearance probability of the cluster transition pattern is a value obtained by dividing the appearance frequency of the cluster transition pattern by the total appearance frequency of all cluster transition patterns.

Further, the appearance frequency of the cluster transition pattern may be a value weighted with the stay period of the cluster transition pattern. A method of storing the appearance probability of the cluster transition pattern in the tensor will be described exemplifying a case in which L is equal to 2, and unique values of all clusters appearing through the past period and the current period are α, β, and γ. At this time, the cluster transition tensor is two-dimensional, and the index of each dimension takes three values of α, β, and γ. When the cluster transition tensor can be expressed by a 3×3 array and the appearance probability of the cluster transition pattern α→β is 0.1, the appearance probability 0.1 is stored in an array element in which the index of the first axis (the first element of the cluster transition pattern) is the value a, and the index of the second axis (the second element of the cluster transition pattern) is the value B.

Step S17: The change point score calculation unit 17 calculates the distance between the cluster transition tensor of the past period and the cluster transition tensor of the current period as a degree of change from the past period to the current period based on the cluster transition tensor of each of the past period and the current period calculated in step S16. When the elements of the cluster transition tensor Dᵢ of the past period are set as d₁^{i1, . . . , iL} and the elements of the cluster transition tensor De of the current period are set as d₂^{i1, . . . , iL}, the distance between the tensors can be expressed by, for example, the following mean squared error.

(Σᵢ₌₁^{L}Σₘ₌₁^{M}(d₂^{i1, . . . ,iL}−d₁^{i1, . . . ,iL})²/M^{L})^{1/2}

Further, in the following inter-tensor distance, M is the number of unique values of all clusters appearing through the past period and the current period.

Step S18: Next, the detection unit 18 detects a change point score as a change point when the change point score calculated in step S17 exceeds a preset threshold. That is, the detection unit 18 detects a change point score as a change point when the score of the change point of the system state calculated based on data (converted data) at each time point exceeds a preset threshold.

Step S19: Finally, the output unit 19 outputs the change point detected in step S18.

### Hardware Configuration

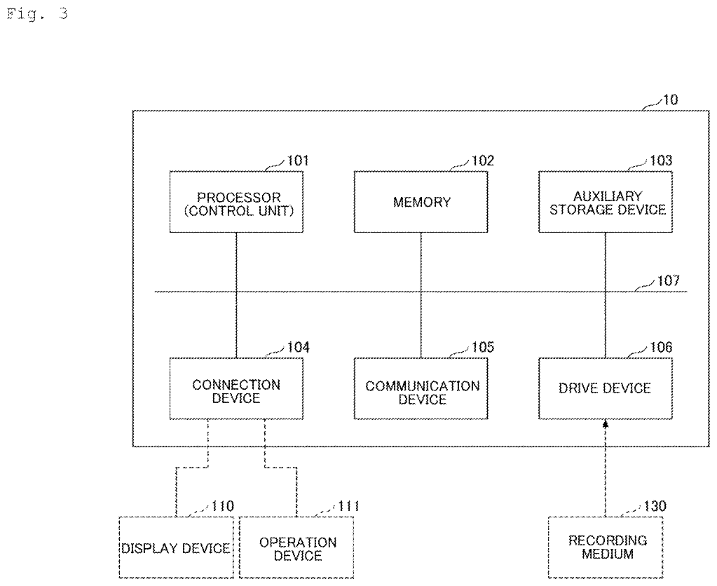

Next, a hardware configuration of the change point detector 10 will be described referring to FIG. 3. FIG. 3 is a diagram illustrating a hardware configuration of the change point detector.

The change point detector 10 includes a processor 101, a memory 102, an auxiliary storage device 103, a connection device 104, a communication device 105, and a drive device 106 as illustrated in FIG. 3. Further, the hardware components of the change point detector 10 are connected to each other via a bus 107.

The processor 101 plays the role of a control unit that controls the entire change point detector 10 and has various computing devices such as a central processing unit (CPU). The processor 101 reads various programs onto the memory 102 and executes them. Further, the processor 101 may include general-purpose computing on graphics processing units (GPGPU).

The memory 102 has main storage devices such as a read only memory (ROM) and a random access memory (RAM). The processor 101 and the memory 102 form a so-called computer, and the processor 101 executes various programs read on the memory 102, thereby enabling the computer to realize various functions.

The auxiliary storage device 103 stores various programs and various kinds of information used by the processor 101 to execute the various programs.

The connection device 104 is a device that connects an external device (for example, a display device 110 or an operation device 111) to the change point detector 10.

The communication device 105 is a communication device for transmitting and receiving various kinds of information to and from other devices.

The drive device 106 is a device for setting a recording medium 130. The recording medium 130 mentioned herein includes a medium that optically, electrically or magnetically records information, such as a compact disc read-only memory (CD-ROM), a flexible disk, or a magneto-optical disk. In addition, the recording medium 130 may include a semiconductor memory for electrically recording information, such as a read only memory (ROM) or a flash memory.

Further, various programs to be installed in the auxiliary storage device 103 are installed, for example, by setting the distributed recording medium 130 in the drive device 106 and reading the various programs recorded in the recording medium 130 by the drive device 106. Alternatively, various programs installed in the auxiliary storage device 103 may be installed by being downloaded from a network via the communication device 105.

### Major Effects of the Embodiment

As described above, the change point detector 10 according to the present embodiment can detect an occurrence time point of a certain change as a change point when the change occurs in a system state by using time-series data representing the system state at each time point of the system(S) including one or a plurality of devices.

Furthermore, the change point detector 10 according to the present embodiment is on the assumption of a method of classifying the system state at each time point by using a clustering method, so time-series data including data which do not satisfy the stationarity restriction and the iid restriction such as data indicating a periodic fluctuation can be targeted. Furthermore, the change point detector 10 according to the present embodiment models a periodic fluctuation of the system(S) by taking into consideration state transitions of the system(S) with the elapse of time (that is, transitions of the cluster to which the system state belongs and the stay period thereof at each time point), and can detect a change including a change in the time change pattern such as a periodic fluctuation.

### Supplementary Notes

The present invention is not limited to the above-described embodiment, and may be configured or processed (operated) as described below.

Although the change point detector 10 can also be realized by a computer and a program, and the program can be recorded in a (non-transitory) recording medium or provided through a network such as the Internet.

### SUPPLEMENT

The present embodiment can be expressed as follows.

### Supplement 1

A change point detector comprising:
a processor, wherein
the processor executes
an input step of inputting time-series data representing a System state at each time point of a system including one or a plurality of devices, the time-series data constituted by data of a dimension of the number of devices included in the system×the number of items representing a state of the devices, a time window generation step of generating converted data by converting the time-series data at each time point from data of the dimension of the number of devices×the number of items into data of a dimension of the number of devices×the number of items×a time window length, and a detection step of detecting a change point score of a system state calculated based on the converted data at each time point as a change point when the change point score exceeds a preset threshold.

### Supplement 2

The change point detector described in Supplement 1, wherein the processor executes
a clustering step of classifying a state of data of a dimension of the number of devices×the number of items×a time window length at each time point constituting the time-series data of a preset past period and a current period by using a clustering method,
a cluster transition sequence creation step of tracking a cluster allocated to the data of the dimension of the number of devices×the number of items×the time window length in a time axis direction, creating a sequence of cluster transitions between different clusters for each of the past period and the current period, and granting a stay period for each cluster constituting the sequence of cluster transitions to the cluster,
a cluster transition tensor calculation step of extracting a cluster transition of a preset fixed length from the sequence of cluster transition sequences, calculating an appearance probability of each cluster transition pattern of the past period and the current period, setting the length of the cluster transition as a dimension, having unique values of all clusters appearing in the past period and the current period in an index of each dimension, and calculating a cluster transition tensor having an appearance probability of each cluster transition pattern as a value for each of the past period and the current period, and
a change point score calculation step of calculating a distance between the cluster transition tensor of the past period and the cluster transition tensor of the current period as a degree of change from the past period to the current period based on the cluster transition tensor calculated for each of the past period and the current period.

### Supplement 3

A change point detection method of causing a computer to execute:
an input procedure of inputting time-series data representing a system state at each time point of a system including one or a plurality of devices, the time-series data constituted by data of a dimension of the number of devices included in the system×the number of items representing a state of the devices,
a time window generation procedure of generating conversion data by converting the time-series data at each time point from data of the dimension of the number of devices×the number of items to data of a dimension of the number of devices×the number of items×a time window length, and a detection procedure of detecting a change point score of a system state calculated based on the converted data at each time point as a change point when the change point score exceeds a preset threshold.

### Supplement 4

A non-transitory recording medium in which a program for causing a computer to execute the method described in Supplement 3 is recorded.

### REFERENCE SIGNS LIST

10 Change point detector
11 Input unit
12 Time window generation unit
13 Period setting unit
14 Clustering unit
15 Cluster transition sequence creation unit
16 Cluster transition tensor calculation unit
17 Change point score calculation unit
18 Detection unit
19 Output unit

1. A change point detector comprising:
a processor; and
a memory storing program instructions that cause the processor to:
input time-series data representing a system state at each time point of a system including one or a plurality of devices, the time-series data being constituted by data of a dimension of the number of devices included in the system×the number of items representing a state of the devices;
generate converted data by converting the time-series data at each time point from data of the dimension of the number of devices×the number of items into data of a dimension of the number of devices×the number of items×a time window length; and
detect a change point score of the system state calculated based on the converted data at each time point as a change point when the change point score exceeds a preset threshold.

2. The change point detector according to claim 1, wherein the program instructions cause the processor to:
classify a state of data of a dimension of the number of devices×the number of items×the time window length at each time point constituting the time-series data of a preset past period and a current period by using a clustering method;
track a cluster allocated to the data of the dimension of the number of devices×the number of items×the time window length in a time axis direction, create a sequence of cluster transitions between different clusters for each of the past period and the current period, and grant a stay period for each cluster constituting the sequence of cluster transitions to the cluster;
extract a cluster transition of a preset fixed length from the sequence of cluster transition sequences, calculate an appearance probability of each cluster transition pattern of the past period and the current period, set the length of the cluster transition as a dimension, have unique values of all clusters appearing in the past period and the current period in an index of each dimension, and calculate a cluster transition tensor having an appearance probability of each cluster transition pattern as a value for each of the past period and the current period; and
calculate a distance between the cluster transition tensor of the past period and the cluster transition tensor of the current period as a degree of change from the past period to the current period based on the cluster transition tensor calculated for each of the past period and the current period.

3. A change point detection method executed by a computer, the method comprising:
inputting time-series data representing a system state at each time point of a system including one or a plurality of devices, the time-series data being constituted by data of a dimension of the number of devices included in the system×the number of items representing a state of the devices;
generating conversion data by converting the time-series data at each time point from data of the dimension of the number of devices×the number of items to data of a dimension of the number of devices×the number of items×a time window length; and
detecting a change point score of a system state calculated based on the converted data at each time point as a change point when the change point score exceeds a preset threshold.

4. A non-transitory computer-readable recording medium storing a program configured for causing a computer to execute the method according to claim 3.
